(19) United States
(12) Patent Application Publication
(10) Pub. No.: US 2016/0103900 A1
(43) Pub. Date: Apr. 14, 2016

(54) DATA STRUCTURING AND SEARCHING METHODS AND APPARATUS

(71) Applicant: University of Lancaster, Lancaster (GB)

(72) Inventors: Plamen Parvanov Angelov, Lancaster University (GB); Pouria Sadeghi-Tehran, Hertfordshire (GB)

(73) Assignee: University of Lancaster

(21) Appl. No.: 14/878,962

(22) Filed: Oct. 8, 2015

(30) Foreign Application Priority Data
Oct. 8, 2014 (GB) 1417807.3

(51) Int. Cl. G06F 17/30

(52) U.S. Cl. CPC G06F 17/30563; G06F 17/30598; G06F 17/3053; G06F 17/30675; G06F 17/30256; G06F 17/30569

(57) ABSTRACT

Various computer implemented methods and data processing apparatus are described for use in structuring digital items and searching a plurality of digital items using a query item. At least one feature of a query digital item is extracted from a data file of the query digital item to form a query feature vector from a plurality of numerical data items representing the feature. It is determined which of a plurality of first clusters is most similar to the query digital item to identify a result cluster from the plurality of first clusters by calculating the aggregated similarity of a plurality of different digital items represented by a one of the first clusters to the query digital item for each of the plurality of first clusters using the query feature vector. Each of the plurality of first clusters represents a different plurality of digital items and each digital item is represented by only one of the plurality of first clusters. A search result is output comprising one or more digital items from the result cluster.

The present invention relates to computer implemented data structuring and searching methods and apparatus and in particular to computer implemented data structuring and searching methods and apparatus for efficiently and reliably searching a large number of digital items.

Computer implemented searching is generally known and generally involves using a query to search amongst a number of different items in a data set to determine which one or ones of the items most closely match the query item. This may apply to structured data, e.g. alphabetically for text, or musical notes for music, etc. However, when data is unstructured (for example photographic images), the unstructured data needs first to be structured to facilitate searching through it. Searching through large unstructured data sets is particularly difficult or inefficient.

Computer implemented searching has a wide range of applications. For example, various search techniques are used by researchers to find or compare DNA sequences. Text searches are used to find documents in databases of documents. Text based searches are also often used to find content on computer networks such as search engines to find web pages or digital content on the internet. Text based searching has its limitations and often involves looking for text strings that have particular relationships with each other such as proximity or order.

Also text based searching can be less effective for digital items which are not themselves text based, such as visual items in the form of image files or audio items in the form of sound files. One approach to searching such non-textual items is generally referred to as tagging in which various text terms which describe the content and nature of the item are associated with the data of the item as meta-data. For example a photograph of a dog may be tagged with the terms “Labrador”, “Jumping” and “Barking”. However, that photograph would be unlikely to be found by a text based search using the query “happy dog” as neither of these terms are present in the tags. Hence, tagging based approaches can be unreliable as they depend on the similarity of the search query and tags. Also, the generation of tags can need to be done manually in order to extract semantic content from the digital item and so can be inefficient when a large number of digital items need to be tagged.

Hence, computer implemented methods and apparatus which can more reliably and more efficiently structure and/or conduct searches of a large number of digital items would be beneficial. Such method and apparatus which can handle ‘Big Data’ will be particularly beneficial.

A first aspect of the invention provides a computer implemented method for searching a plurality of digital items using a query digital item, comprising: extracting at least one feature a query digital item from a data file of the query digital item and forming a query feature vector from a plurality of numerical data items representing the at least one feature; determining which of a plurality of first clusters is most similar to the query digital item using the query feature vector to identify a result cluster from the plurality of first clusters, wherein each of the plurality of first clusters represents a different plurality of digital items and each digital item is represented by only one of the plurality of first clusters; and outputting a search result comprising one or more digital items from the result cluster.

Searching based on features extracted from digital items can help to increase the reliability of searching as it avoids subjectivity such as is introduced in tagging or similar methods. Also, the features can be extracted using automatic processes rather than needing any manual input. Further, the use of clusters to represent multiple digital items can help to increase the efficiency of searching.

The determining may further comprise calculating the aggregated similarity of all of the plurality of different digital items represented by a one of the first clusters to the query digital item for each of the plurality of first clusters using the query feature vector. All the digital items are represented by the plurality of clusters, but the digital items are compared at a cluster level using aggregate similarity thereby allowing a relatively few simple calculations to be used compared to the number of digital items effectively being included in the search.

The plurality of first clusters may be at a first level of a hierarchy of clusters, the first level being a lowest level of the hierarchy of clusters. The hierarchy of clusters may further include a plurality of second clusters at a second level of the hierarchy. The method may further comprise determining which of the plurality of second clusters is most similar to the query digital data item to identify the plurality of first clusters by calculating the aggregated similarity of a plurality of first clusters represented by a one of the second clusters to the query digital item for each of the plurality of second clusters using the query feature vector, wherein each of the plurality of second clusters represents a different one or plurality of first clusters and each first cluster is represented by only one of the plurality of second clusters. Using a hierarchical structure of clusters, in which clusters at a higher level are each used to represent multiple clusters at a lower level, the searching method can be applied to very large collections or groups of digital items while still being computationally practicable using readily available computing resources.

Extracting at least one feature can comprise extracting a plurality of features from the data file of the query digital item and forming the query feature vector from a plurality of numerical data items representing each of the plurality of features. Using multiple different extracted features, which are each characteristic of a different property or quality of the digital item, can improve the reliability of the search results.

Each cluster can be defined by a plurality of cluster data items which have been recursively calculated using an evolving local means method. This provides a computationally efficient mechanism, in terms of the simplicity of calculations carried out and data storage requirements, for forming clusters representing the digital items and/or clusters representing cluster means.

Outputting a search result can include determining the similarity between the query digital item and each of the digital items represented by the result cluster. A threshold can be applied to select the one or more digital items to output as the search results. Preferably the search results comprise a plurality of digital items. The number of digital items output as the search results can be in the range of 10 to 100, for example 20.

The computer implemented method can further comprise ranking the digital items represented by the result cluster based on the determined similarity. Outputting the search results includes outputting the one or more digital items in rank order from more similar to less similar. This can make it easier for a user to assess the search results as the more digital items can be presented ordered by similarity to the user.

The digital items can be images. The or each feature may include one or more image features selected from the group comprising: an image feature obtained from a GIST scene description of the image; an image feature obtained from an HSV histogram of the image; an image feature corresponding to a colour moment of the image; an image feature obtained from a colour autocorreolgram of the image; an image feature obtained from a log-Gabor texture filtering of the image; and an image feature obtained from a wavelet transformation of the image. When a plurality of image features are used in the feature vector, then at least four, five or six different image features or groups of image features can be used. This can help to improve the reliability of the search results. The image feature or features may correspond to a property or properties of individual pixels of the image. The image feature or features may correspond to a property or properties of the entire image. The image features may correspond to a property or properties of individual pixels of the image and a property or properties of the entire image. The order of preference of the image features, from most preferred to least preferred, is: colour autocorrelogram, log-Gabor filtering, GIST scene description, wavelet transformation, colour moments, and HSV histogram. Other image features which may also be used include one or more of: high zero-crossing rate ratio (HZCRR), low short-time energy ratio (LSTER), spectrum flux (SF), band periodicity (BP), and noise frame ratio (NFR).

The digital items can be audio items. The or each feature includes one or more audio features selected from the group comprising: an audio feature representing the timbral texture of the audio item; an audio feature representing the rhythmic content of the audio item; and an audio feature representing the pitch content of the audio item. Other audio features may include, or be derived from, one or more of Rhythm Patterns, Fluctuation Patterns, Statistical Spectrum Descriptors and Rhythm Histograms.

The method may further comprise sending a search request over a computer network to a remote searching service. The method may further comprise receiving the search result over the computer network from the remote searching service. The search request may be sent from a client computer associated with a user of a searching service. The searching service may be provided as a web service and may be hosted by one or more web servers connected or otherwise in communication with the computer network. The searching service may be provided by or as part of a search engine.

The search request includes the query feature vector. The query feature vector may be generated by a process local to a client computer of a user.

The search request may include the data file of the query digital item or the location on the computer network of the data file for the query digital item. This allows the search service to obtain the data file either directly or indirectly form the search request and then generate the query feature vector.

A second aspect of the invention provides a computer readable medium, or computer readable media, storing computer program code executable by a data processor, or data processors, to carry out the method according to the first aspect of the invention and/or any preferred features thereof.

A third aspect of the invention provides a data processing device, or devices, for searching a plurality of digital items using a query item, each data processing device including a data processor and the computer readable medium, or a one of the computer readable media, according to the second aspect of the invention.

A fourth aspect of the invention provides a computer implemented method for processing a plurality of digital items to structure the plurality of digital items, and preferably to be searchable using a query item, The method may comprise: extracting at least one feature from a data file for each of a plurality of digital items and forming a feature vector of a plurality of numerical data items representing the at least one feature for each of the plurality of items; and forming a plurality of first clusters by recursively calculating a plurality of first cluster data items for each of the plurality of first clusters from the feature vector using an evolving local means method, wherein each plurality of first cluster data items defines a respective one of the plurality of first clusters, and wherein each cluster of the plurality of first clusters represents a different plurality of digital items and each digital item is represented by only one of the plurality of first clusters.

Structuring digital items based on features extracted from digital items can help to increase the reliability of structuring them and avoids subjectivity such as is introduced in tagging or similar methods. Also, the features can be extracted using automatic processes rather than needing any manual input. Further, the use of an evolving local means method to form clusters representing multiple digital items can help to increase the efficiency of processing large numbers of digital items so as to be more reliably structured, and in particular searchable, as relatively few simple calculations may be used initially to generate the clusters, and subsequently to update the clusters as further digital items become available.

Structuring large sets of digital items can be beneficial in other areas outside of search, for example to help store the data items or effectively compressing the data items. The structured data items may also be processed for other reasons, such as extracting relations between the cluster or association rules between the clusters, and similar.

The computer implemented method can further comprise forming at least one second cluster by recursively calculating a plurality of second cluster data items for each second cluster from the first cluster data items using an evolving local means method, wherein each plurality of second cluster data items defines a respective second cluster, and wherein each second cluster represents a different one or plurality of first clusters and each first cluster is represented by only one second cluster, and wherein the plurality of first clusters are at a first level of a hierarchy of clusters, the first level being a lowest level of the hierarchy of clusters and each second cluster is at a second level of the hierarchy. Using a hierarchical arrangement of clusters, in which one or more clusters higher in the hierarchy represent one or multiple clusters lower in the hierarchy, can help improve the efficiency of structuring large data sets or subsequently processing a search query.

The computer implemented method may further comprise forming a plurality of second clusters by recursively calculating a plurality of second cluster data items for each of the plurality of second clusters from the first cluster data items using an evolving local means method, wherein each plurality of second cluster data items defines a respective one of the plurality of second clusters, and wherein each cluster of the plurality of second clusters represents a different one or plurality of first clusters and each first cluster is represented by only one of the plurality of second clusters, and wherein the plurality of second clusters are at a second level of the hierarchy.

The or each of the plurality of second level clusters may be formed with a second cluster radius, the plurality of first clusters may be formed with a first cluster radius and the second cluster radius may be greater than the first cluster radius. This allows multiple first level clusters to be represented by second level clusters. Adjusting the second level cluster radius may vary the number of first level clusters represented by a second level cluster. Generally speaking the or each cluster at a higher level of the hierarchy may have a greater radius than the or each cluster at an immediately lower level of the hierarchy. A cluster radius may be considered a measure of the size of a cluster in the features space of the clusters.

The computer implemented method may further comprise determining if the number of clusters at a lower level of the hierarchy is greater than a threshold and if so then generating at least one higher level cluster at a higher level of the hierarchy by recursively calculating a plurality of higher level cluster data items for each higher level cluster from the cluster data items for the clusters at the lower level using the evolving local means method, wherein each plurality of higher level cluster data items defines a respective higher level cluster, wherein each higher level cluster represents a different one or plurality of clusters at the lower level and each cluster at the lower level is represented by only higher level clusters. This helps to control the number of levels in the hierarchy. The threshold may be in the range from 100 to 1000. Preferably the threshold is less than 10,000, more preferably less than 5000 and most preferably less than 1000.

The computer implemented method may further comprise maintaining a data structure encoding or otherwise representing which lower level cluster or clusters are represented by a higher level clutter for the or each higher level cluster. The data structure may store cluster identifiers for the or each lower level cluster represented by a higher level cluster.

The computer implemented method may, further comprise iterating the method to form a hierarchy having at least three, at least four, at least five or at least six levels. Greater numbers of levels improve the ability to efficiently structure very large data sets including billions of different digital items.

The computer implemented method may further comprise obtaining the data file for each of the plurality of digital items at a server by retrieving the data files over a computer network. Obtaining the data file may include or comprise crawling or searching the computer network. The obtaining of data files may be carried out on a regular, periodic or intermittent basis.

The computer implemented method may further comprise receiving a search request including or identifying a query digital item over the computer network at the server computer from a client computer associated with a user. The search request may include a query feature vector for the query digital item, a data file of the query digital item, or an identifier for the query digital item or its data file or an address on the computer network for the query digital item or its data file.

Extracting at least one feature may comprise extracting a plurality of features from the data file of each digital item and forming the feature vector from a plurality of numerical data items representing each of the plurality of features for each of the plurality of digital items.

The digital items may be images. The or each feature may include one or more image features selected from the group comprising: an image feature obtained from a GIST scene description of the image; an image feature obtained from an HSV histogram of the image; an image feature corresponding to a colour moment of the image; an image feature obtained from a colour autocorreolgram of the image; an image feature obtained from a log-Gabor texture filtering of the image; and an image feature obtained from a wavelet transformation of the image.

The digital items may be audio items. The or each feature may include one or more audio features selected from the group comprising: an audio feature representing the timbral texture of the audio item; an audio feature representing the rhythmic content of the audio item; and an audio feature representing the pitch content of the audio item.

A fifth aspect of the invention provides a computer readable medium storing computer program code executable by a data processor to carry out the method according to the fourth aspect of the invention and/or any preferred features thereof.

A sixth aspect of the invention provides a data processing device for processing a plurality of digital items to be structured, or to be searchable using a query item, the data processing device including a data processor and a computer readable medium according to the fifth aspect of the invention.

Embodiments of the invention will now be described in detail, by way of example only, and with reference to the accompanying drawings, in which:

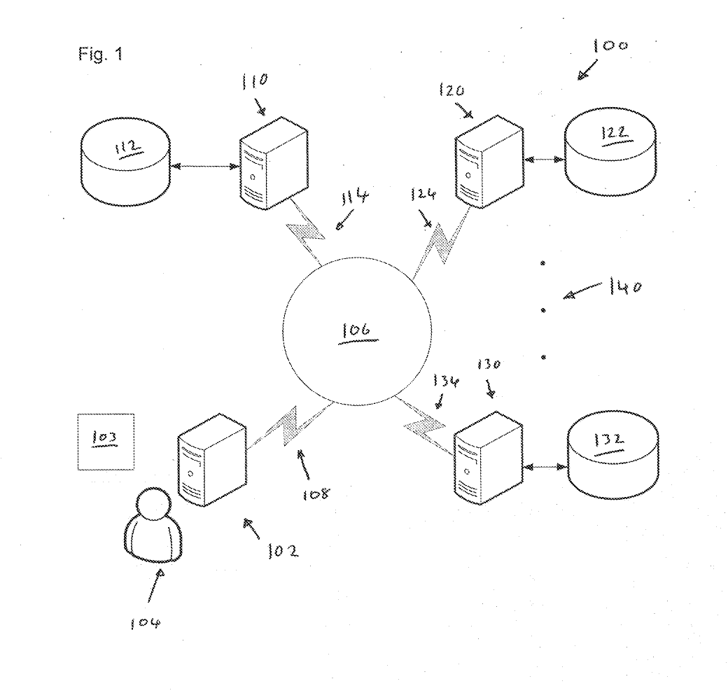

FIG. 1 shows a schematic block diagram of a computer system in which the method and apparatus of the invention can be used;

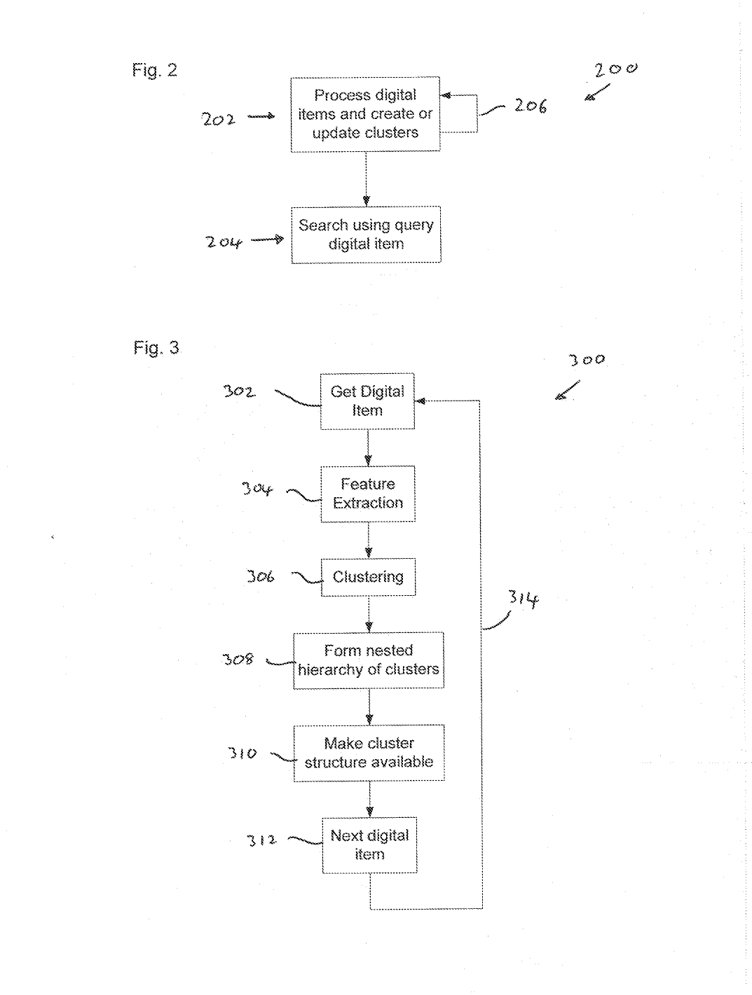

FIG. 2 shows a process flow chart illustrating a structuring stage and search stage of an overall method in which various aspects of the invention can be used;

FIG. 3 shows a process flow chart illustrating the structuring stage of FIG. 2 in greater detail;

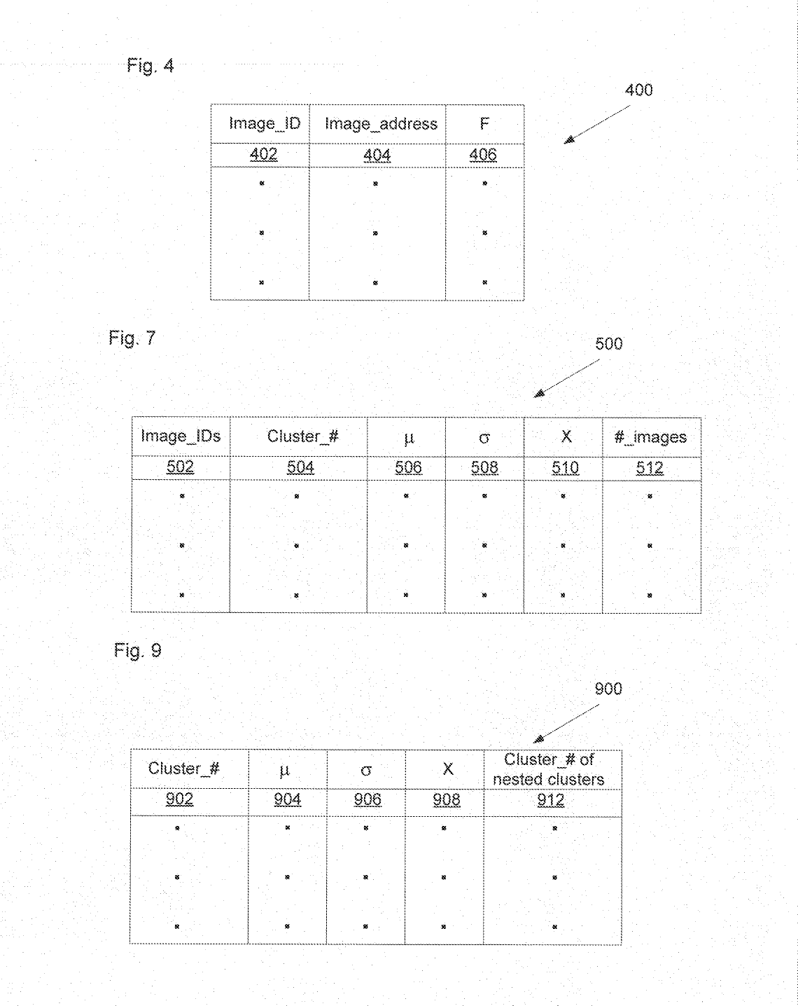

FIG. 4 shows a data structure in the form of a table storing image related data and used by the method illustrated in FIG. 3;

FIG. 5 shows a process flow chart illustrating a feature extraction part of the method illustrated in FIG. 3;

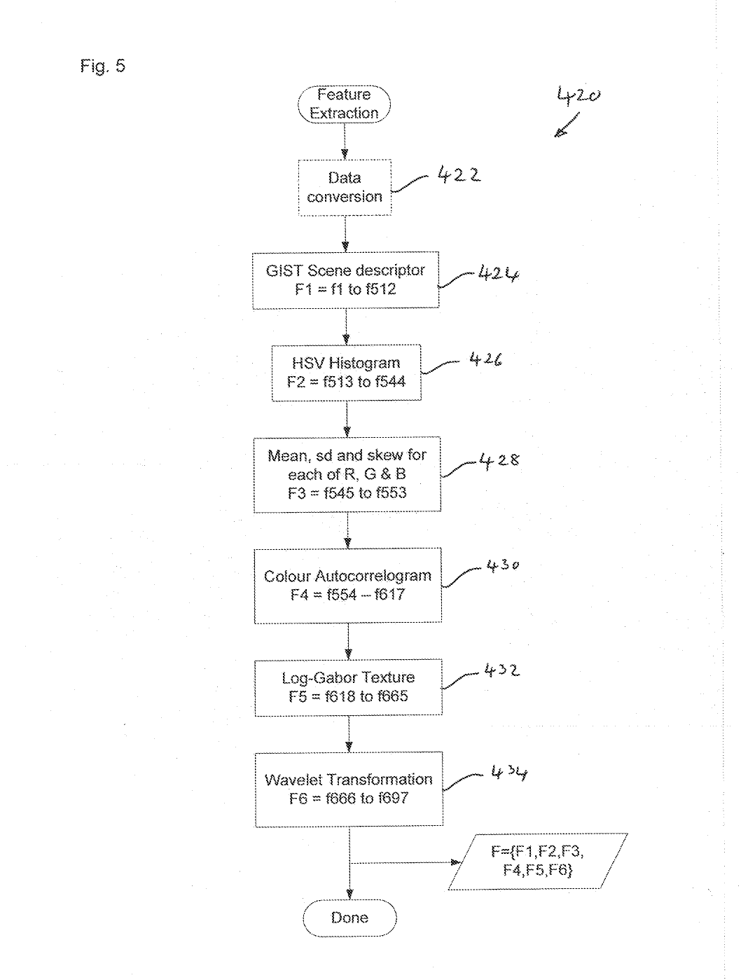

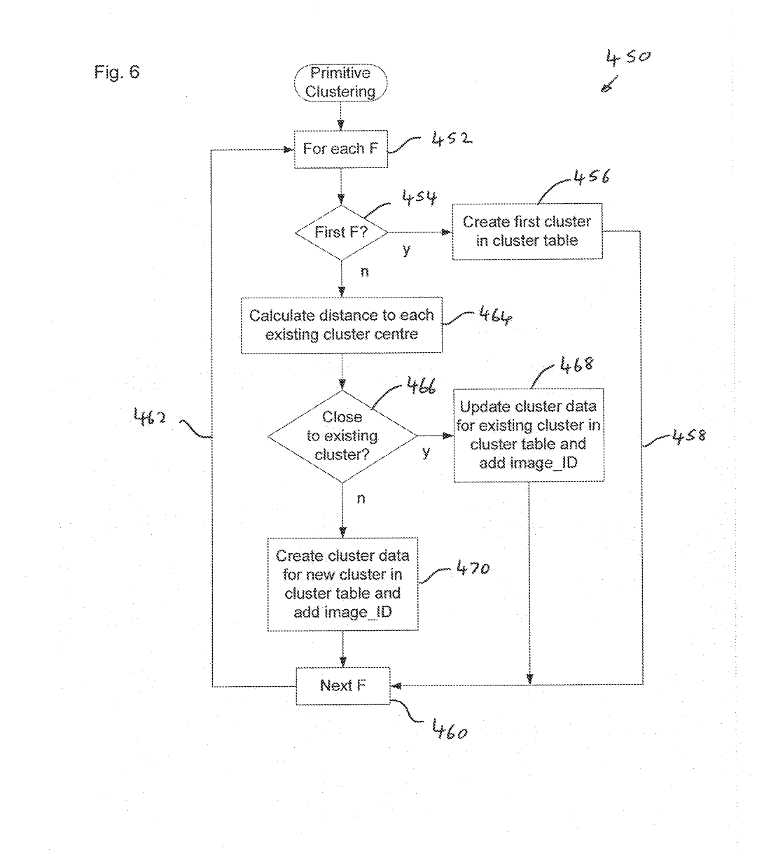

FIG. 6 shows a process flow chart illustrating a lowest level clustering part of the method illustrated in FIG. 3;

FIG. 7 shows a data structure in the form of a table of lowest level clustering related data and used by the method illustrated in FIG. 6;

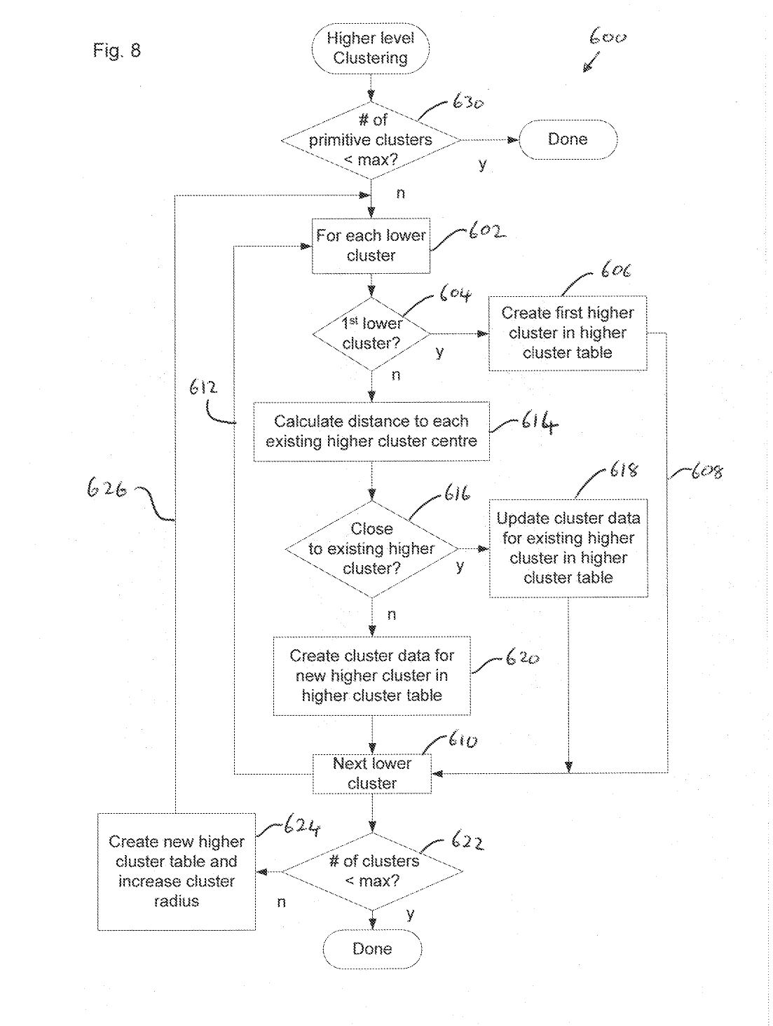

FIG. 8 shows a process flow chart illustrating a method of generating a nested hierarchy of clusters and being part of the method illustrated in FIG. 3

FIG. 9 shows a data structure in the form of a table storing data used by the method illustrated in FIG. 8;

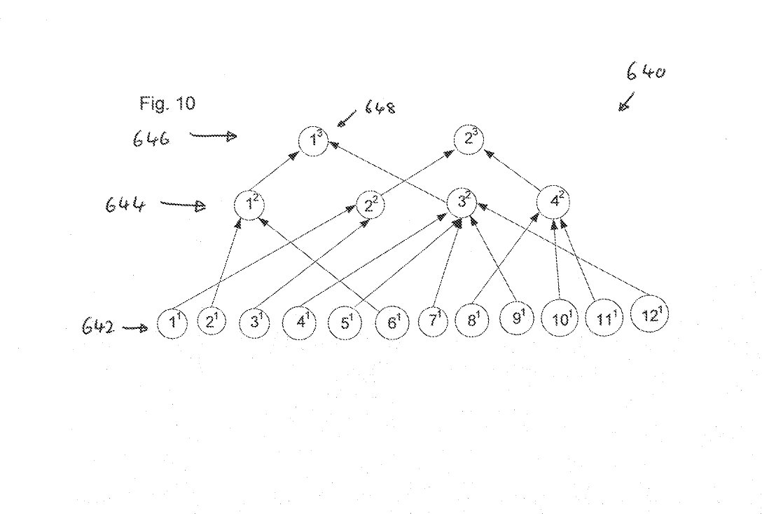

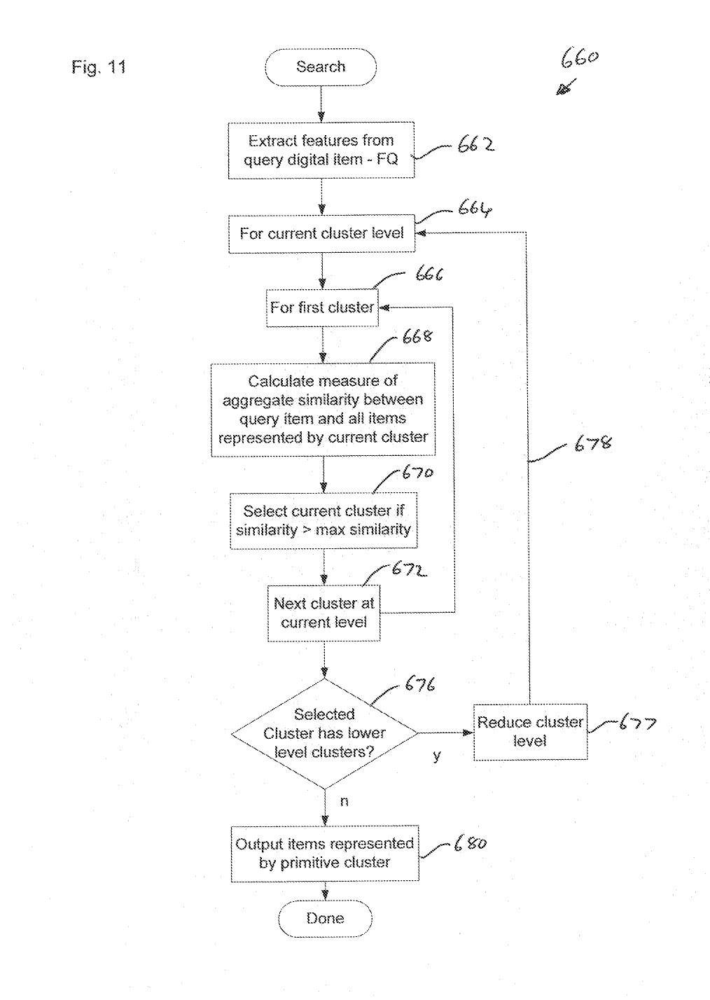

FIG. 10 shows a graphical representation of a nested hierarchy of clusters that can result from the method illustrated in FIG. 8;

FIG. 11 shows a process flow chart illustrating a search stage of the overall method illustrated in FIG. 2;

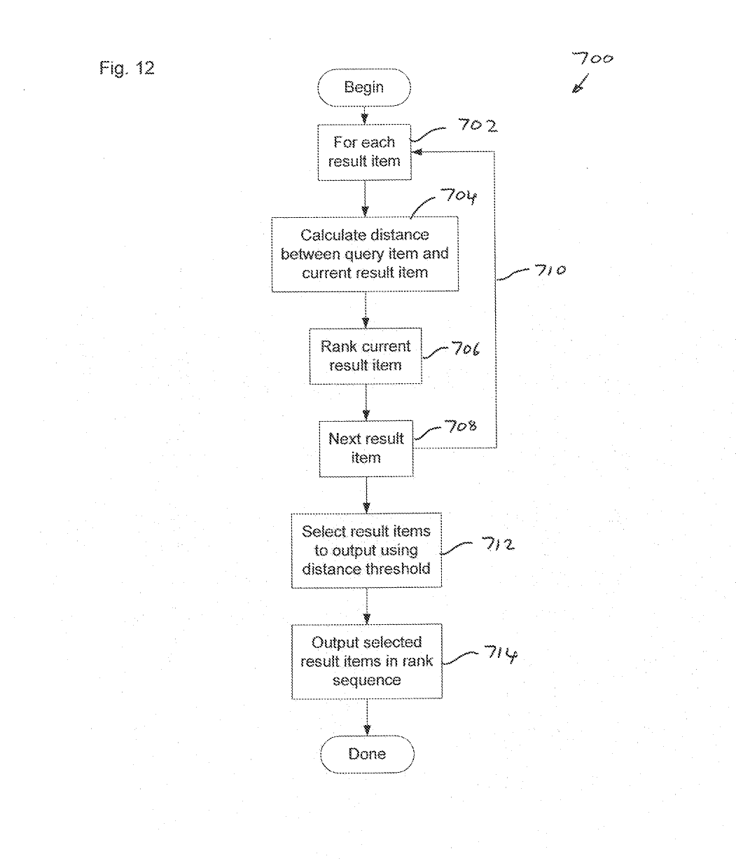

FIG. 12 shows a process flow chart illustrating a search results output stage of the search method illustrated in FIG. 11; and

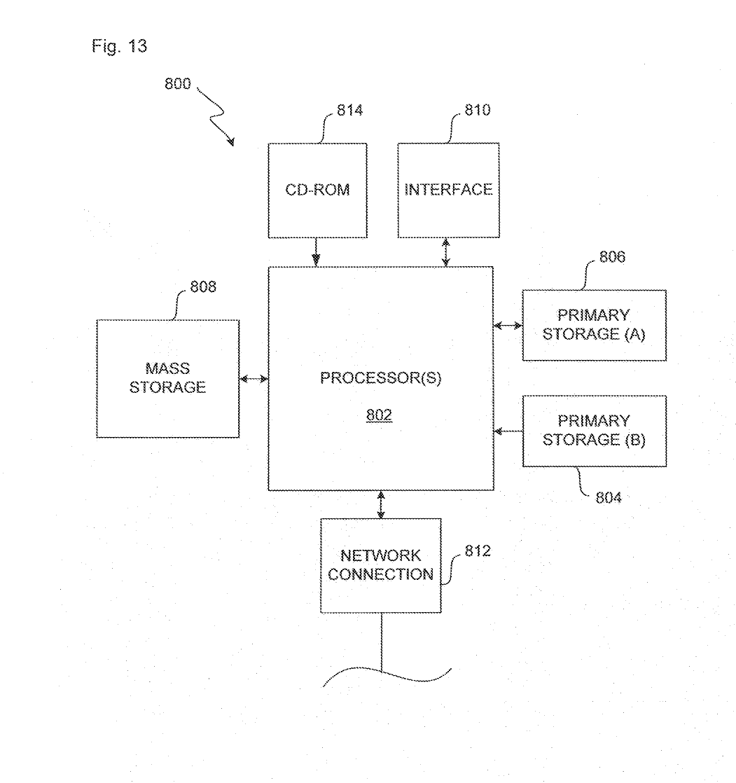

FIG. 13 shows a schematic block diagram of a data processing device according to the invention and which can be used to implement various method aspects of the invention.

Like items in the different Figures share common reference numerals unless indicated otherwise.

The present invention is applicable to a wide range of different types of digital items. While embodiments of the invention are described below with reference to the examples of images, such as photographs, and sounds, the invention is not limited to only those types of digital items. Rather, the invention can be applied to any type of digital item which can be characterised by a feature vector as described below.

With reference to FIG. 1 there is shown, a schematic block diagram of a computer system 100 according to an aspect of the invention and in which various data processing apparatus according to aspects of the invention and implementing various methods according to aspects of the invention. The computer system 100 includes a client computer 102 associated with a user 104 and which is connected to a network 106, such as the internet, via a communication link 108. The computer system 100 also includes a first server 110 which can provide a search service to client computer 102. Search server 110 has access to a database 112 which stores various data items, described in greater detail below, generated and used by the search server to service search requests received over network 106 to which the search server is connected via communication link 114.

A second server 120 is also connected to the network 106 via a communication link 124 and has access to a database or storage device 122 which stores a first large collection of digital items, such as image files. For example second server 120 may provide a photo sharing website or similar and database 122 may store the actual image files which can be viewed via photo sharing web server 120.

A third server 130 is also connected to the network 106 via a communication link 134 and has access to a database or storage device 132 which stores a second large collection of digital items, such as image files. For example third server 130 may provide a stock image service or similar and database 132 may store the actual image files which can be viewed and purchased via stock image web server 130.

As indicated by ellipsis 140 various other repositories of large collections of digital items which are accessible via the network 106 can also be provided and the invention is not limited to the specific system shown in FIG. 1. Further, other types of digital items can be searched using the invention such as audio files and any other digital item which can be characterised by features represented using numerical values.

The invention is particularly useful in searching vary large numbers of digital items quickly and reliably. The invention is particularly applicable to structuring and searching Big Data. The networked computer system embodiment illustrated in FIG. 1 reflects this and is an environment in which the invention is particularly useful. However, the invention is not limited to a distributed or networked computing environment and can in other embodiments be provided on a local network or entirely locally by a single computing device which both generates search request and services search request being a merging of the functionalities provided by client computer 102 and search server 110.

FIG. 2 shows a flow chart illustrating the different stages of the overall search related method 200 at a high over view level. The overall method 200 includes an initial data structuring step 202 which takes place before a search 204 can be conducted. The approach to searching is based on generating clusters in the data structuring step 202. Clusters at a lowest level of the hierarchy each represent a plurality of actual individual digital items which are somehow similar. A nested hierarchical arrangement of clusters can also be generated during the data structuring stage 202 which improves the efficiency with which a very large number of digital items can be represented. A cluster at a higher level of the hierarchy is related to one or more clusters at a lower level. Hence one or more lower level clusters are nested within each higher level cluster. Each digital item is processed in the same way to extract a plurality of features which characterises the digital item. A search is then conducted by processing a query digital item in the same way to extract the same plurality of features. The plurality of features of the query item are then used to determine which cluster is most similar to the query item, and then working down through any lower levels of clusters, to arrive at a lowest level cluster which represents a group of actual digital items most similar to the query digital item.

As illustrated in FIG. 2, by return process flow line 206, the structuring of digital items can be an ongoing process which happens as new digital items become available for processing. Initially all pre-existing digital items of a collection are processed so that they can be searched. As new digital items are added to the collection or otherwise become available, then those new digital items can also be processed so as to be searchable. Adding new digital items may result in updating existing clusters and/or updating the structure of the hierarchy of clusters.

Hence, the overall approach of method 200 can be applied to any type of digital item from which a plurality of features, which represent properties or characteristics of the digital item, can be extracted and represented numerically.

FIG. 3 shows a process flow chart illustrating a computer implemented method 300 of structuring digital items so that they are searchable and corresponding generally to step 202 of FIG. 2. The structuring method 300 may be carried out by search service server 110. The structuring method 300 begins at 302 by obtaining a new digital item to be processed. For example, search service server 110 may crawl the Internet looking for images which have been published or otherwise made available since a last processing cycle. Additionally, or alternatively, images may be supplied or pushed to the search service server 110 for structuring periodically or intermittently.

The search service server database 112 stores various data items relating to images being or that have been processed. FIG. 4 shows an image table 400 representing a data structure for storing various processed image related data items. The image table 400 includes a first field 402 for storing an image identifier data item “Image_ID” which provides a unique identifier for each image which has been processed by the search service server 110. The image table 400 also includes a second field 404 for storing an image address data item “Image_address” which provides address information for the location of an actual image file for each image which has been processed by the search service server 110. For example, the image address data item may be a URL for the image file. The image table 400 includes a third field 406 for storing a feature vector data item “F” which is a numerical representation of the features extracted from the image after processing by the search service server 110. A separate record is maintained for each image file that has been processed by the search service server 110.

Returning to FIG. 3, when a new image file is obtained by the search service server at 302, a new record is created in the image table 400, a new Image_ID is created and stored in the table and the address of the image file on the network is stored in the image table 400. At step 304 the image file is processed to extract a plurality of different features which are characteristic of different properties or qualities of the image. The different features are combined into a feature vector, F, which is stored in the image table 400. The feature extraction processes carried out at step 304 are illustrated in greater detail in FIG. 5.

FIG. 5 shows a process flow chart illustrating the feature extraction process 420 which can include one or more processes be carried out using image data from the image file to extract features from the image and build the feature vector F. A first step 422 can include extracting the image data from the image file, for example decompression, and also converting the format of the image data into that used by the system. This may involve converting between different colour spaces such as RGB, HSV, YC_{b}Cᵣ or other generally known colour spaces. As is generally known in the art, RGB refers to a colour space defined by red, green and blue components, HSV to a colour space defined by hue, saturation and value of intensity components, and YC_{b}Cᵣ to a colour space defined by luma, or luminance, blue difference and a red difference components. Ultimately, the image data is extracted from the image file and provided as three ‘colour’ values for each pixel of the image.

It has been found that using only a single feature, e.g. colour or texture, is not very efficient and may result in matches with images which are not similar to a query image. In order to achieve robust image matching a combination of six feature extraction processes can be used to cover six different properties or qualities of the image. While the six sets of features described below have been found to provide optimum reliability of search results a reduced number can also be used while still providing usefully reliable search matches. In other embodiments, a greater number may also be used.

At step 424 a first group of extracted features, F1, are based on the GIST scene descriptor described in Olivia, A. and A. Torralba, Modeling the Shape of the Scene: A Holistic Representation of the Spatial Envelope, International Journal of Computer Vision, 2001, 42(3): p. 145-175 and Oliva, A. and A. Torralba, Building the gist of a scene: The role of global image features in recognition, Progress in brain research, 2006, 155, p. 23-36. The basis of the GIST approach is to extract the global features of the image which gives an impoverished and coarse version of the principal contours and textures of the image, but which are still detailed enough to recognize the image. It is computationally efficient and there is no need to parse the image, or group its components, in order to represent the spatial configuration of the scene. The image is decomposed at different spatial scales from low to high spatial frequency. The basis of the GIST approach is Gabor filters. Several Gabor filters with selected channels are computed on a 4×4 grid of the image and indexed into an array. This array is called GIST of the scene which represents the spatial layout of the image.

Each global feature value is a weighted combination of the output magnitude of a bank of multi-scale, multi-oriented filters. Principal components analysis (PCA) is used to set the weights. Due to high dimensionality of each image, applying PCA directly to the vector of features composed by the output magnitudes of the filters would be computationally expensive. In order to address that, the dimensionality of the vector is reduced by down sampling each filter output to a size M×M. As a result, each image is represented by a vector of M×M×S×O elements, where S denotes the number of scales, O is the orientation, and M×M is the number of samples used to encode, at low resolution, the output magnitude of each filter. In the described embodiment a 4×4 grid partition is used with scale S=4 and orientation 0=8 giving a total of 512 GIST features, in the first feature group F1, and being elements f1 to f512 for the overall feature vector F.

At step 426 a second group of extracted features, F2, are based on a colour HSV histogram. Each pixel of the image is associated to a specific histogram having 32 bins on the basis only of its own colour. The HSV (Hue, Saturation, and Intensity Value) colour space is used for histogram generation which offers improved perceptual uniformity and represents the three colour variants Hue, Saturation and Value of Intensity. This separation has advantages compared to the RGB colour space due to independent colour processing performance. Also, it is easier to compensate colour distortions. For instance, lighting and shading are typically isolated to the lightness channel. For the HSV colour histogram, the distribution of the number of pixels for each quantised bin is defined for each colour component. Quantisation, in relation to colour histograms, refers to the process of reducing the number of distinct colours used in the histogram (to represent the image). This is described in greater detail in Chen, W.-T., W.-C. Liu, and M.-S. Chen, Adaptive Color Feature Extraction Based on Image Color Distributions, IEEE TRANSACTIONS ON IMAGE PROCESSING, 2010, 19(8): p. 2005-2016. In the present embodiment, the image is quantised in HSV colour space into 8×2×2 equal bins, which creates 32 HSV colour histogram features, in the second feature group F2, and being elements f513 to f544 of the overall feature vector F.

At step 428, a third group of extracted features, F3, are colour moments. Colour moments provide a measurement for colour similarity between images which can be used to differentiate images based on their colour. The distribution of colours in an image can be defined as a probability distribution. Then probability distributions are characterised by a number of unique moments. Most of the information is concentrated in the low-order moments, and so the first central moment, known as mean, the second central moment, known as standard deviation, and the third central moment, known as skewness, are extracted for each of the image's three colour distributions. The image is defined by 9 moments in total, 3 moments for each RGB or HSV channel. Hence, step 428 generates 9 colour moment features, in the third feature group F3, and being elements f545 to f553 of the overall feature vector F.

The mean can be considered as the average colour value in an image and can be calculated using:

$${M}_{c} = {\sum }_{i = 1}^{N} \frac{1}{N} {p}_{ci} \qquad ( 1 )$$

where N=H×W, H=height in pixels, W=width in pixels and p_{ci} is the value of the i-th image pixel, for the c-th colour channel.

The standard deviation is the square root of the variance of the distribution and can be calculated using:

$${σ}_{c} = \sqrt{\frac{1}{N} {\sum }_{i = 1}^{N} {( {p}_{ci} - {M}_{c} )}^{2}} \qquad ( 2 )$$

Skewness can be considered a measure of the degree of asymmetry in the distribution and can be calculated using:

$${S}_{c} = \sqrt[3]{\frac{1}{N} {\sum }_{i = 1}^{N} {( {p}_{ci} - {M}_{c} )}^{3}} \qquad ( 3 )$$

At step 430, a fourth group of extracted features, F4, are based on the colour autocorrelogram of the image. A colour histogram only describes the colour distribution in an image and does not include spatial information about the colour in the image. On the other hand, a colour correlogram is a spatial extension of the histogram. The colour auto-correlogram provides the fourth group of features, F4, and which describes the global distribution of local spatial correlations of colours.

The colours in the image are quantised into m colours c₁, c₂, . . . , cₘ (where m=64 in this embodiment, using the same binning approach as step 426) and the histogram h of image I for colour cᵢ is defined by:

h_{c}_{ᵢ}(I) [symbol] n²·Pr[pεI_{c}_{ᵢ}] (4)

where the image, I, has n×n pixels p=(x, y)εI. For any pixel in the image, h_{C}_{ᵢ}(I)/n² gives the probability that the colour of the pixel is cᵢ. If the distance d ε [n] is fixed a priori, the correlogram of I is defined for i ε R^{m}; j ε R^{m} as:

β_{c}_{ᵢ}_{c}_{ⱼ}^{κ}(I)≡Pr└|p₁−p₂|=κ; p₂εI_{C}_{ᵢⱼ}|p₁εI_{C}_{ᵢ}┘ (5)

where |p₁−p₂| [symbol] max{|x₁−x₂|, |y₁−y₂|}; κ⊂d.

Given any pixel of colour cᵢ in the image I, β_{c}_{ᵢ}_{c}_{ⱼ}^{κ} gives the probability that a pixel at distance κ away from the given pixel is of colour cⱼ. For each pixel in the image, the auto-correlogram method considers all the neighbours of that pixel. Therefore, the computation complexity is of order O (d×m²). The auto-correlogram of image I computes spatial correlation between identical colours only:

α_{c}^{κ}(I)≡β_{c}^{κ}(I) (6)

In that case, the information is a subset of the correlogram and the computational complexity is of order O (d×m²). If the distance is large, a large area will be covered and more information will be collected from the image. However, the computation complexity will increase. Also, larger storage would be required. On the other hand, too small a distance might decrease the quality of the feature. In order to address the computational complexity and storage requirement, a distance set D is used which is a subset of d(D={1,3,5,7}) resulting in a 64 features forming the fourth group, F4, and being elements f554 to f617 of the overall feature vector, F.

At step 432, a fifth group of extracted features, F5, are extracted relating to the texture of the image. Texture describes the content of images such as clouds, seas, fabric, and skins. Texture can therefore provide important information in image classification. A log-Gabor function is used for the fifth extracted feature set which relates to texture.

Texture is generally the structure of surfaces formed by repeating a particular element or several elements in different relative spatial positions. Generally, the repetition involves local variations of scale, orientation, or other geometric and optical features of the elements. Image textures can contain important information about the structural arrangement of the surface, i.e., fabric, bricks, etc., and can also describe the relationship of the surface to the surrounding environment.

The Gabor wavelet can be used to extract texture from images and has been shown to be very efficient. Gabor filters are a group of wavelets, with each wavelet capturing energy at a specific frequency and specific orientation. In other words, it is a multi-scale, multi resolution filter. The scale and orientation property of a Gabor filter makes it especially useful for texture analysis. However, the bandwidth of a Gabor filter is limited to one octave. Therefore, a large number of filters are required to obtain wide spectrum coverage. In addition, their response is symmetrically distributed around the centre frequency, which results in redundant information in the lower frequencies that could instead be devoted to capturing the tails of images in the higher frequencies.

An alternative to the Gabor function is the log-Gabor function designed as Gaussian functions on the log axis. The log-Gabor function is described in greater detail in Field, D. J., Relations between the statistics of natural images and the response properties of cortical cells, J. Opt. Soc. Amer, 1987, 4(12), pp. 2379-2394. Their symmetry on the log axis results in a more effective representation of the uneven frequency content of the images. Furthermore, log-Gabor filters do not have a DC component, which allows an increase in the bandwidth which results in fewer filters to cover the same spectrum. It has been shown that a log-Gabor filter outperforms the standard Gabor filter in verifying an object in an image. The log-Gabor filters are defined in the log-polar coordinates of Fourier domain as Gaussian shifted from the origin:

$$\begin{matrix}{G}_{( s , o )} ( ρ , θ ) = exp ( - \frac{1}{2} {( \frac{ρ - {ρ}_{s}}{{σ}_{ρ}} )}^{2} ) exp ( - \frac{1}{2} {( \frac{θ - {θ}_{( s , o )}}{{σ}_{θ}} )}^{2} ) & ( 7 ) \\ \{ \begin{matrix}{ρ}_{s} = {log}_{2} ( n ) - s \\ {θ}_{( s , o )} = \{ \begin{matrix}\frac{π}{{n}_{o}} o & if s is odd \\ \frac{π}{{n}_{o}} ( o + \frac{1}{2} ) & if s is even\end{matrix} \\ ( {σ}_{ρ} , {σ}_{θ} ) = 0.996 ( \sqrt{\frac{2}{3}} , \frac{1}{\sqrt{2}} \frac{π}{{n}_{o}} )\end{matrix} & ( 8 )\end{matrix}$$

where s and o specify the scale and orientation of the wavelet respectively (s=0, 1, . . . , nₛ; t=0, 1, . . . , nₒ) and (ρ, θ) are the log-polar coordinates. The coordinates of the centre of the filter are (ρₛ, θ_{(s,o)}) and (σ_{ρ}, σ_{θ}) are the bandwidths.

If FT denotes the Fourier transform of the input image, then the convolution of G_{s,o} and F is obtained by:

V_{s,o}=FT*G_{s,o} (9)

An array of magnitudes is obtained as:

$${E}_{s , o} = {\sum }_{x} {\sum }_{y} \vert {V}_{s , o} ( x , y ) \vert \qquad ( 10 )$$

where (x,y) denotes the 2D coordinates of a pixel p_{x,y}.

These magnitudes represent the energy content at different scale and orientation of the image. The main purpose of texture-based searching is to find images or regions with similar texture. It is assumed that images or regions that have homogenous texture are of interest. Therefore, the following mean μₛₒ and standard deviation σₛₒ of the magnitude of the transformed coefficient are used to represent the homogenous texture feature of the region:

$$\begin{matrix}{μ}_{so} = \frac{{E}_{s , o}}{H \times W} & ( 11 ) \\ {σ}_{so} = \frac{\sqrt{{\sum }_{x} {\sum }_{y} {( \vert {G}_{so} ( x , y ) \vert - {μ}_{so} )}^{2}}}{H \times W} & ( 12 )\end{matrix}$$

where H and W are the height and width in pixels of the image and their product is equal to N, the total number of pixels.

The fifth group of features, F5, is constructed using μₛₒ and σₛₒ. In the embodiment, the scale is set to 4 (i.e. s=4) and the orientation is set to 6 (i.e. o=6) which results in 24 features for each of μₛₒ and σₛₒ. Hence, there are 48 features in the fifth group, F5, being elements f618 to f665 of the overall feature vector F.

At step 434, a sixth group of extracted features, F6, are obtained from a wavelet transform process which involves transformations of pixel intensities and models the image at several different resolutions. The wavelet representation of the image provides information about variations in the image at different scales. The Discrete Wavelet Transform (DWT) represents an image as a sum of wavelet functions with different locations and scales. A wavelet is a multi-resolution analysis of an image and represents both the space and frequency domain. Decomposition of a 1D image into a wavelet involves a pair of waveforms: the high frequency components correspond to the detailed parts of the image while the low frequency components correspond to the smooth parts of the image. A DWT for a 2D image can be implemented as a 1D DWT applied to every row of the image and then a 1D DWT applied to every column of the image. Decomposition of a 2D image into wavelets involves four sub-band elements representing LL (Approximation), HL (Vertical Detail), LH (Horizontal Detail), and HH (Detail), respectively, and is described in greater detail in Arai, K. and C. Rahmad, Wavelet Based Image Retrieval Method, International Journal of Advanced Computer Science and Applications, 2012, 3(4), pp 6-11.

The DWT of a signal x is calculated by passing it through a low pass filter with impulse response h and a high pass filter with impulse response g. The outputs giving the detail coefficients (from the low pass and high-pass filter) and approximation coefficients.

$$\begin{matrix}{w}_{low} [ n ] = {\sum }_{k = - ∞}^{∞} x [ k ] h [ 2 n - k ] & ( 13 ) \\ {w}_{high} [ n ] = {\sum }_{k = - ∞}^{∞} x [ k ] g [ 2 n - k ] & ( 14 )\end{matrix}$$

Wavelet transformation can be applied several times to the image. The image is initially resized into 256 pixels×256 pixels, and a 4-level wavelet transformation is applied. An upper left 16 pixel×16 pixel matrix is stored and is also divided into its high and low frequency components to form part of the feature vector. Finally, the mean of the 16×16 matrix is calculated to give 16 features and the standard deviation of the 16×16 matrix is calculated to give another 16 features. Hence, there are 32 features in the sixth group, F6, being elements f666 to f697 of the overall feature vector F.

Hence, at the end of method 420 a feature vector F has been generated F={f₁, . . . , f₆₉₇} which includes 697 elements each being a numerical value. The feature vector F is stored in the image data table 400. Feature extraction is now complete for the current image and processing proceeds to step 306 of FIG. 3 at which a clustering process is carried out. FIG. 6 shows a process flow chart illustrating the clustering process 450 corresponding to step 306 in greater detail.

The clustering process uses an evolving local means method to generate clusters of similar images based on their respective feature vectors, F. The evolving local means (ELM) method is described generally in Baruah, R. D. and Angelov, P., Evolving Local Means Method for Clustering of Streaming Data, in IEEE World Congress on Computational Intelligence, 2012, Brisbane, Australia, pp. 2161-2168. The Evolving Local Means method is based on the concept of non-parametric gradient estimate of a local, per data cluster density function using an Epanechnikov kernel, which reduces to updating the local, per cluster mean. The local mean for each cluster is updated for each new feature vector which allows the data set to evolve as new images become available and are processed. Generally speaking, a new cluster is created if the density pattern changes sufficiently. The evolving nature of the method is hence useful if new images become available, for example by being uploaded or otherwise published on the Internet. For each cluster, i, that is being formed a local mean, μᵢ and variance, σ_{I}, are calculated from the feature vector, F. The mean does not necessarily, and usually does not, represent a meaningful image but is rather an abstraction of all the images represented by the cluster.

In the Evolving Local Means method, an initial radius, r of a cluster is defined for each level of the hierarchy: r(1) for the lowest level, r(2) for the next higher level, etc. The radius provides a threshold, or value, that is defined, and which determines the zone of influence of a cluster. The radius of a cluster is compared with the variance (see equation (15) below) in order to determine if a new data item is within or outside the zone of influence of a cluster and hence should or should not be associated with this cluster. In this embodiment, it has a single value being the magnitude of a vector in the feature space of F. In terms of the feature vector, F, the initial radius value for clusters in the lowest hierarchical level is set, in this example, to r(1)=150 and for clusters in higher levels is set using r(j+1)=r(j)+δr, where δr, the increase in cluster radius for each level of the hierarchy, is 100 for this example, and where j denotes the level of the clusters, j=1, 2, . . . . In this example images with a resolution of 256 by 256 pixels were used. For other resolutions other values of the radiuses may be used. For example, for higher resolutions, larger radiuses may be used. When a new image is processed, and a new feature vector F is available, the distance to all existing cluster centres is computed. If

dᵢ<(max(∥σᵢ∥,r)+r) (15)

where dᵢ is the Euclidean distance from a current image to a cluster mean μᵢ and r is the radius of the cluster, then it means that the region around image and the region around the cluster cᵢ overlap, and so the image is assigned to the cluster i.

If the region around the image overlaps with more than one cluster, then the nearest cluster is selected (i.e. the cluster with the largest overlap). After assigning the new incoming image to an existing cluster, then the centre of the cluster i and the variance, o are updated recursively as described in Baruah, R. D. and P. Angelov supra.

In particular, the mean value of F, μₖ, the scalar product of F, Xₖ and the variance, σₖ can be updated recursively as follows:

$$\begin{matrix}{μ}_{k} = \frac{k - 1}{k} {μ}_{k - 1} + \frac{1}{k} {F}_{k} {μ}_{1} = {F}_{1} & ( 16 ) \\ {X}_{k} = \frac{k - 1}{k} {X}_{k - 1} + \frac{1}{k} {‖ {F}_{k} ‖}^{2} {X}_{1} = {‖ {F}_{1} ‖}^{2} & ( 17 ) \\ {σ}_{k}^{2} = \frac{k - 1}{k} {σ}_{k - 1}^{2} + \frac{1}{k} {‖ {F}_{k} - {μ}_{k} ‖}^{2} {σ}_{1}^{2} = 0 & ( 18 )\end{matrix}$$

As noted in the above, for a very first image, the mean value of F is simply F₁ and the scalar product X is simply (F₁)² and the variance is zero, σ₁=0.

As mentioned above, when very large data sets are being structured, the method uses a nested hierarchy of clusters, in which the number of levels of the hierarchy depends on the number of digital items being structured. When a lower number of digital items are to be searched, e.g. up to a few tens of thousands, then a hierarchy of clusters need not be used and only lowest level, or primitive, clusters may be generated, with each lowest level cluster representing multiple images. However, for greater numbers of digital items, e.g. hundreds of thousands and greater, then two or more levels of clusters may be used in which clusters at a higher hierarchical level than the lowest level clusters, higher level clusters, are used, with each higher cluster representing or being associated with one or multiple lower level clusters.

FIG. 6 shows a process flow chart illustrating the primitive clustering method 450 used to generate the primitive or lowest level clusters. At step 452 a new feature vector F is selected. At step 454 it is determined if the feature vector is a very first feature vector for the collection of images. If it is then processing proceeds to step 456 at which a first primitive cluster is created using the first feature vector F₁. Creating a cluster generally corresponds to calculating various data items which define the cluster. At step 456 a number of data items are generated by the search service server 110 and written to a lowest level, or primitive, clusters table 500 stored in database 112.

FIG. 7 shows a primitive clusters table 500 representing a data structure for storing various data items relating to primitive clusters. The primitive clusters table 500 includes a first field 502 for storing image identifier data items “Image_ID” for each of the images assigned to a particular primitive cluster, and obtained from the image table 400. The primitive clusters table 500 also includes a second field 504 for storing a cluster number data item “Cluster_#” which provides a unique identifier for each primitive cluster that has been generated by the search service server 110. The primitive clusters table 500 also includes a third field 506 for storing a recursively calculated mean value, μ, of the feature vector, F, a fourth field 508 for storing a recursively calculated variance, σ, of the feature vector and a fifth field 510 for storing a recursively calculated scalar product, X, of the feature vector. The primitive clusters table also includes a sixth field 512 for storing the number of images that have been assigned to the cluster, “#_images”. A separate record, or row, is generated and maintained for each primitive cluster in the primitive clusters table 500 by the search service server 110.

Returning to FIG. 6, at step 456, a first primitive cluster is created by generating and storing a cluster number, storing the image_ID for the image corresponding to the current feature vector, the mean value of F is set to F₁, the variance is set to zero and the scalar product is set to (F₁)², and the number of images in the cluster is set to 1. Processing then proceeds along process flow line 458 to step 460 at which a next feature vector, F₂, is selected for processing and process flow returns 462 to step 452. As this is a second feature vector, at step 454 processing proceeds to step 464. At step 464 the distance between the current feature vector and each existing primitive cluster is determined. In the current example, there is only one primitive cluster currently existing, and hence only one cluster centre, and so at step 464, the Euclidean distance between F₂ and the centre of the first primitive cluster, given by its mean feature vector 506, is calculated.

Then at step 466 it is determined whether the new feature vector F₂ is close to any of the existing clusters and if so which one it is closest to using equation (15) above. Continuing the present example, if it is determined that F₂ is sufficiently close to the first primitive cluster, then processing proceeds to step 468 and the cluster data for the first primitive cluster is updated in primitive clusters table 500. In particular, the image_ID for the second image is added to field 502, the mean value of F and σ and the value of X are recursively calculated using equations (16), (17) and (18) supra, and the count of the number of images in the primitive cluster, #_images, is incremented in field 512.

Alternatively, if at step 466 it is determined that that F₂ is not sufficiently close to the first primitive cluster, then processing proceeds to step 470 and a further primitive cluster is created in primitive clusters table 500. In particular, a new record or row is added to the primitive clusters table 500, and the image_ID for the second image is stored in field 502, the mean value of F, μ, and the value of X are set to initial values corresponding to F₂ (as this is the first feature vector for the new cluster) and the count of the number of images in the primitive cluster, #_images, is set at 1.

The processing 450 is repeated as illustrated by process flow line 462 and step 460 every time a feature vector is newly available and results in either the new feature vector being assigned to an existing primitive cluster, whose properties are then modified, or a new primitive cluster being created.

Returning to FIG. 3, after the lowest level, or primitive, clustering step has been completed for the new digital item, then processing moves on to step 308 at which a nested hierarchy structuring process may be carried out to either introduce a nested hierarchy of clusters, if not previously present, or to modify an existing nested hierarchy of clusters. FIG. 8 shows a process flow chart illustrating a nested hierarchy structuring process 600 corresponding to step 308 in greater detail. Process 600 is similar to primitive clustering process 450, but instead of clustering images using their feature vector, F, it clusters means of lower level clusters, μ, and forms clusters representing one or a plurality of lower level clusters, rather than clusters which represent the digital items themselves. An initial step 630 determines whether to add a first level of the hierarchy above the lowest primitive cluster level. There may be little processing efficiency increase obtained by adding a higher level of clusters if the number of primitive clusters is relatively low. Hence, at step 630 it is determined whether the number of primitive clusters is sufficiently low in which case no higher level clusters are formed and the method can end. For example, step 630 may involve comparing the number of primitive clusters, which corresponds to the number of records in the primitive clusters table 500, with a threshold value, e.g. 1000. If there are more than the threshold number of primitive clusters, then the introduction of one or more higher level clusters may improve processing efficiency and so the remainder of the process 600 is carried out.

Structuring process 600 uses a higher level clusters table 900 illustrated in FIG. 9 and representing a data structure for storing various data items relating to clusters higher in the hierarchy of clusters than the primitive clusters. The higher clusters table 900 includes a first field 902 for storing a cluster identifier data items “Cluster_#” which provides a unique identifier for each higher cluster that has been generated by the search service server 110. The higher clusters table 900 also includes a second field 904 for storing a recursively calculated mean value, μ, of the mean feature vector values for the lower clusters, a third field 906 for storing a recursively calculated variance, a, of the mean feature vector values for the lower clusters, a fourth field 908 for storing a recursively calculated scalar product, X, of the mean feature vector values associated with the lower level clusters. A separate record, or row, is generated and maintained for each higher cluster, at the same level in the cluster hierarchy, in the higher clusters table 900 by the search service server 110. A separate higher clusters table like table 900 is provided for each level of the cluster hierarchy above the lowest level of the primitive clusters. A data structure is also maintained which encodes the nested hierarchical relationship between the clusters, for example storing pointers to the different clusters and which lower level clusters are related to which higher level cluster. In the described embodiment, higher cluster table 900, includes a fifth field 912 for storing the cluster_#'s for each of the lower level clusters which are represented by, or nested in, a higher level cluster. Hence, the data in field 912 encodes the nested hierarchical relationship by identifying which lower level clusters are nested within a higher level cluster.

Returning to FIG. 8, the process for creating, or updating, the nested hierarchy of clusters 600 selects a first lower level cluster. Initially, the lower level cluster will be from the lowest level, i.e. a primitive cluster. At step 604 it is determined if the lower level cluster is the first one, in which case a first potential higher level cluster is created in the higher cluster table 900 at 606 using the mean, μ, variance, σ, and scalar product, X of that first lower level cluster. Also, the cluster_# for the first primitive cluster is added to the data structure encoding the relationship between the higher and lower level clusters, for example by adding the cluster_# for the first primitive cluster to field 912 of table 900. Processing then proceeds as indicated by process flow line 608 to step 610 at which any next cluster at the current lower cluster level being evaluated, in this example primitive clusters, is identified and processing returns as indicated by process flow line 612 to step 602. At step 604 processing proceeds to step 614 as the current cluster is now the second primitive cluster. At step 614, the distance between the mean value, μ of the second primitive cluster and the mean value, μ, of each existing next higher level cluster is determined. At step 616 it is determined whether the mean of the second primitive cluster is sufficiently close to the mean of the first higher level cluster using equation (15) above and with a larger cluster radius appropriate for a higher level cluster at a first higher level above the primitive cluster level. If it is then at step 618, the higher cluster table for the first higher level cluster is updated and the number of primitive clusters in the first higher level cluster is incremented to two. Also, the data structure maintaining the structure of the cluster hierarchy, e.g. field 912 of table 900, is updated to show that the second primitive cluster is represented by the first higher level cluster, for example by adding the cluster_# for the second primitive cluster to field 912.

Processing returns via step 610 at which a third primitive cluster is selected. If at step 616 it is determined that the mean of the third primitive cluster is not sufficiently close to the mean of the first higher level cluster, then processing proceeds to step 620 at which a second higher level cluster is created by generating a new record or row in higher level cluster table 900. Hence, processing continues to loop until the mean values of all of the primitive clusters have been evaluated and one or more higher level clusters at a first level in the cluster hierarchy above the primitive clusters level are formed.

At step 622 it is determined whether a further iteration of the structuring process should be carried out to add another level to the cluster hierarchy. If there are a large number of higher level clusters, in this example cluster at the first level above the primitive clusters, then a further iteration of structuring will improve the efficiency of the search process. Step 622 determines whether the number of clusters at the currently highest level of the hierarchy is less than some threshold value, for example one thousand. The number of clusters at the currently highest level of the hierarchy simply corresponds to the number of records in the higher cluster table 900, as each record corresponds to a different higher level cluster. If not, then processing proceeds to step 624. A new higher cluster table is created at step 624 for higher level clusters at a next higher level in the hierarchy, in this example two levels above the primitive level, and the higher level cluster radius is increased by δr, which in the described example is 50. Processing then returns as illustrated by process flow return line 626 and steps 602 to 622 are repeated. However, in this iteration, the lower level clusters are now at the first level of the hierarchy above the primitive, lowest level clusters and the higher level clusters are now at the second level of the hierarchy above the primitive clusters. Processing can continue to loop around line 626 until the number of higher level clusters is below the maximum number threshold condition at step 622 at which stage the process 600 ends. A preferred maximum number of clusters at the highest hierarchical level is 1000. Above that value, processing efficiency can be significantly improved by introducing another higher level to the hierarchy instead.

The result of the forming nested hierarchy of clusters at step 308 is illustrated in FIG. 10. FIG. 10 shows a pictorial representation of nested hierarchy of clusters 640, including a first level 642 of 12 primitive clusters, primitive cluster numbers 1¹ to 12¹, a second level 644 of 4 first higher level clusters, higher cluster numbers 1² to 4², and a third level 646 of 2 second higher level clusters, higher cluster numbers 1³ to 2³. The ‘nesting’ of the clusters is illustrated in FIG. 10, at the highest level, cluster 1³ 648 represents clusters 1² and 3² of the second level which respectively represent primitive clusters 2¹ and 6¹ and primitive clusters 4¹, 5¹, 7¹ and 9¹. Each primitive cluster represents a plurality of the actual digital items, in this example images. Hence, one or more clusters at a lower level are nested within a single cluster at a higher level.

FIG. 10 shows a much reduced number of clusters and hierarchical levels compared to the number that would actually be used in practice for a large number of items but serves to illustrate the principle. For example, a trillion (10¹²) digital items (the number of images believed to be uploaded on the Internet as of autumn 2014) can easily be represented by a nested hierarchy of clusters having just six levels of hierarchy with each cluster representing 100 lower level items, as ((10²)⁶=10¹²). Such a structure can also easily accommodate a large amount of further digital items by adding higher levels and can also be easily parallelised.

Returning to FIG. 3, after the hierarchical grouping of clusters illustrated in FIG. 10 has been created by step 308, processing proceeds to step 310 at which the updated hierarchy of clusters is made available or made live for use to service search request by the search service server 110. For example this may involve changing the status of the tables 400, 500, 900 stored in database 112 from pre-production to production. At step 312 a next newly available digital item is selected and process flow returns 314 to step 302. This results in updated tables being made available after every newly processed digital item. However, in other embodiments, newly updated tables made be made available on a periodic basis, e.g. every day or hour, or only after a processing a number of new images, e.g. every hundred or thousand newly processed images.

Once the primitive clusters, and any hierarchy of nested clusters, have been created then a search of the processed images can be conducted using a query image as indicated by step 204 of FIG. 2. The search step 204 corresponds to finding the primitive or lowest level data cluster that represents the most similar images to the query image. In order to do that, a local recursive density, γₖⁱ estimation approach is used to estimate the similarity between the query image, Qₖ and all of the images represented by an i^{th} cluster. The inverse, πₖⁱ of the local recursive density, γₖⁱ represents the accumulated distance between the query image and the cluster mean. Thus, by minimising πₖⁱ the similarity between the query image and all elements of the cluster is maximised. It should be noted that higher level clusters also effectively represent all of the images which are represented by the primitive clusters which the higher level clusters represent. The local recursive density estimation approach is described generally in International Patent Application Publication No. WO2013/171474, and Angelov, P., Autonomous Learning Systems: From Data Streams to Knowledge in Real Time., 2012, John Wiley and Sons. Such a recursive technique allows each image to be processed only once and then discarded once it has been processed, rather than retained in memory. Only the information concerning density, μ and X, is accumulated and stored in the memory. Moreover, the number of computations that need to be made is much smaller (reduced by orders of magnitude) compared to other approaches. The recursive nature of the algorithm, makes the search process computationally efficient and fast, and can be expressed as:

$${C}^{*} = arg {min}_{i = 1}^{\# clusters} \{ {π}_{k}^{i} \} , \\ {π}_{k}^{i} = \frac{1}{{γ}_{k}^{i}} - 1 ; \\ {γ}_{k}^{i} = \frac{1}{1 + {‖ {Q}_{k} - {μ}_{k}^{i} ‖}^{2} + {X}_{k}^{i} - {‖ {μ}_{k}^{i} ‖}^{2}} \qquad ( 19 )$$

in which C* is the cluster containing the image most similar to the query item.

In equation (19), Q, represents the query feature vector and equation (19) is used to calculate a density of the distribution of the images in the feature space, gamma, from which an accumulated proximity, pi, can be calculated using equation (20).

$${π}_{k}^{i} = \frac{1}{{γ}_{k}^{i}} - 1 ; \qquad ( 20 )$$

In equation (20), as π is the inverse of the density it represents dissimilarity. Hence, the cluster for which π is minimum is determined, which means that cluster has the lowest dissimilarity, and therefore greatest the similarity to the query feature vector. This general approach is carried out at each level of the cluster hierarchy starting form the highest level and then moving down only to the most similar cluster at the next lower level until the primitive cluster level is reached.

FIG. 11 shows a process flow chart illustrating a searching process 660 and corresponding generally to step 204. Referring back to FIG. 1, a user 104 has a query digital item 103, e.g. a digital photograph that they have taken, and that they want to use to conduct a search to find similar images. A first step 662 of the search process involves creating a feature vector for the query image, F_{Q}, the same as the feature vectors used to process the images to be searched. Hence, step 662 corresponds generally to the feature extraction process 420 illustrated in FIG. 4. The feature extraction process may be carried out by code local to the user's client computer 102 and then the query feature vector, F_{Q}, may be sent to the search service server 110 with a search request. For example, the feature extraction process may be provided as an applet executed by a browser application resident on the client computer 102. In other embodiments, the image file for the digital image 103 may simply be sent to the search service server 110 as part of the search request and a process on the search service server may extract the features from the image file.

When the search request is received by the search service server 110 then the search service server 110 uses the query feature vector F_{Q} to conduct the search of all currently processed images. At step 664, a highest cluster level of the cluster hierarchy is selected, e.g. the third cluster level 646 of the cluster hierarchy 640 illustrated in FIG. 10. At step 666 a first cluster of the current level of the hierarchy is selected, e.g. cluster 1³ 648 of FIG. 10. Then at step 668 the similarity between the query image, as represented by query feature vector F_{Q}, and the images represented by the current cluster is calculated. It should be noted that this is an aggregate similarity and considers all of the images ultimately represented by the current cluster. As discussed above, at step 668, equation (19) is used to determine γ and then equation (20) is used to determine π which is a measure of dissimilarity and hence a lower value of π corresponds to higher similarity.

At step 670, the current cluster is selected as the most similar if its similarity is greater than a current maximum similarity. Hence, step 670 essentially checks and notes whether the currently evaluated cluster i represents the most similar images to the query image. As noted above, a higher level clusters represents images in the sense that it represents all the images contained in all the lower level clusters that the higher level cluster represents, or put another way, are nested within it. Hence, a currently evaluated cluster is selected as the most similar cluster of those so far evaluated at step 670 if its πₖⁱ is a minimum of those clusters so far evaluated.

At step 672, any next cluster at the current level is selected for evaluation, in this example, cluster 2³ of FIG. 10 and then process flow returns 674 to step 666. This process repeats for each cluster at the current level. After all the clusters at the current level have been evaluated and the cluster at the current level most similar to the query image has been identified and selected, in this example cluster 1³. Then processing proceeds to step 676 which determines whether the selected cluster represents lower level clusters or not. This determines whether the selected cluster is a primitive cluster or not. If it is determined that the selected cluster is not a primitive cluster at step 676 then processing proceeds to 676 at which the cluster level is reduced by one, from level three 646 to level two 644 in the current example, and processing returns to 664. At step 666 a first cluster for the new, lower level and which is represented by the selected higher level cluster is selected for evaluation, in this example, cluster 1. Processing proceeds as above and the similarity of the query image to clusters 1² and 3² is determined to see which cluster the query image is more similar to.

If cluster 1² is selected as the most similar cluster to the query image, then at step 676 it is determined that there are lower level clusters 2¹ and 6¹. Processing then repeats for these two primitive clusters to see which of these two primitive clusters the query image is most similar to and then selecting the most similar primitive cluster. However, now at step 676 it is determined that there are no lower level clusters associated with primitive cluster 6¹ and hence the group of images represented by this primitive cluster has now been found. Hence, at step 680, some or all of the images represented by the selected primitive cluster can be output as the search results. The primitive cluster table 500 includes all the image_IDs for each cluster and the image table 400 includes image address data indexed by the image_ID data item. Hence, the image_ID data items can be used to obtain the image addresses. The image address data can then be placed in image tags, e.g. an HTML <img> tag, in a web page which is sent by the search service server 110 back to the user's client computer 102. The images can then be displayed by their web browser which can obtain the image file using their URL in the image tags. This helps to reduce the processing load on the search server. Hence, in some embodiments, all the images in a primitive cluster can be returned as the search results for user inspection and evaluation.

In other embodiments, once the primitive cluster has been identified, further processes can be used to improve the search results to select a subset of images from the primitive cluster to be returned as the search results to the user. For example, FIG. 12 shows a process 700 for further refining the search results. Once the primitive cluster which includes the most similar images to the query image has been found, all of the images in the primitive cluster are ranked using a relative Manhattan distance (also referred to as city distance or L₁) which yields good results and helps to identify more significant differences between two images. A small distance between the query image and an image form the primitive cluster implies that the corresponding image is more similar to the query image and vice versa. The relative Manhattan distance between the query image and images inside the selected cluster can be computed using:

$$D ( {Q}_{k}^{j} , {F}_{k}^{j} ) = \frac{{\sum }_{j = 1}^{{n}_{F}} \vert {Q}_{k}^{j} - {F}_{k}^{j} \vert}{1 + {Q}_{k}^{j} + {F}_{k}^{j}} \qquad ( 21 )$$

where n_{F} is the number of extracted features, which is 697 in the described embodiment (F={f₁, . . . , f₆₉₇}), and where Q is the query image feature vector and F is the cluster image feature vector.

At step 702, a first result image from the search result cluster is selected and at step 704 the distance between the query image and current result image is calculated using equation 20 and stored. The calculated distance is then also used to establish and store a similarity rank for the current image, e.g. 1^{st}, 2^{nd}, 3^{rd}, 4^{th}, etc., at step 706. Then a next result image from the results cluster is selected at step 708 and processing returns 710 and the next result image is evaluated, its distance calculated and ranked. After all the result images from the result cluster have been evaluated, then at step 712 a distance threshold is used to select a subset of result images to be actually output to the user. For example a threshold of approximately 20 has been found to provide a reasonable number of results for user assessment. Then at step 714, the subset of result images can be output in rank sequence, so that the result images can be displayed arranged in similarity order (most similar to less similar). Hence, search service server 110 can return the image files for the subset of result images and their associated rank to the user computer 102 so that the web browser can display the subset of result mages in order of decreasing similarity (most similar to least) to the user 104.

As noted above, the invention is not limited in application to images and can be applied to other types of digital item, such as audio items. As will be appreciated the feature vector, F, will vary depending on the type of digital item to be searched.

For audio items, the feature vector includes a plurality of different features which can be extracted from an audio file and represented numerically and which are characteristic of some property or quality of the audio item. For example, feature sets for representing the timbral texture, rhythmic content and pitch content of an audio item are described in “Musical Genre Classification of Audio Signals”, Tzanetakis, G. and Cook, P., IEEE 30 TRANSACTIONS ON SPEECH AND AUDIO PROCESSING, Vol. 10, No. 5, July 2002, pages 293-302. Hence, the method of the invention can also be used to search audio items but using a feature vector including a plurality of groups of features extracted from Audio files rather than image files. Other feature sets extractable from audio files and other combinations of features can also be used.

Other audio features can also be used. For example three feature sets can be computed for audio items in standard PCM format with 44.1 kHz sampling frequency (e.g. decoded MP3 files). A first audio feature set is known as Rhythm Patterns (RP), also called Fluctuation Patterns, which denote a matrix representation of fluctuations on critical bands (parts of it describe rhythm in the narrow sense), resulting in a 1.440 dimensional feature space, and hence 1,440 audio item features. A second audio feature set is known as Statistical Spectrum Descriptors (SSDs, having 168 dimensions) which are statistical moments derived from a psycho-acoustically transformed spectrogram, and hence provides 168 audio item features. A third audio feature set is Rhythm Histograms (RH, 60 dimensions) are calculated as the sums of the magnitudes of each modulation frequency bin of all 24 critical bands. Additional or alternative audio item features sets are described in Lie Lu, Hong-Jiang Zhang, and Hao Jiang, “Content analysis for audio classification and segmentation,” IEEE Trans. Speech Audio Process., vol. 10, no. 7, pp. 504-516, October 2002.

Rhythmic and pitch content feature sets can be computed over a whole audio file. This approach is acceptable if the audio file is relatively homogeneous but is not appropriate if the audio file contains regions of different musical texture.

If real-time performance is desired, then only the timbral texture feature set should be used. It might possible to compute the rhythmic and pitch features in real-time using only a portion of the audio data from an audio file rather than the entire audio file.

An analysis window of 23 ms which captures 512 samples at a 22 050 Hz sampling rate) and a texture window of 1s (which includes 43 analysis windows) can be used to extract the audio features.

For the Beat Histogram calculation, the DWT may be applied in a window of 65 536 samples at a 22 050 Hz sampling rate which corresponds to approximately 3s. This window is advanced by a hop size of 32 768 samples. A larger window is used to capture the signal repetitions at the beat and sub-beat levels.

The invention provides a particularly fast search method for digital items. For example, when applied to finding visually similar images in huge data bases, a combination of a few hundred image features of different nature, a dynamically evolving hierarchical structure of image clusters and a single recursive density estimation (RDE) formula applied locally to an image cluster provides a reliable and very efficient search method. The search method is computationally efficient generally, and also and time-wise very efficient, due to the combination of the hierarchical cluster structure (for very large collections of digital items) and the use of the local RDE for similarity determination. The reliability of the search results is also robust and provides visually meaningful results due to the combination of hundreds of extracted features of various natures. The local RDE formula provides exact information about the similarity between any given query image and all images represented by a cluster.

Based on experimental results, it is believed that the method is capable of real-time image retrieval from a very large collection of images. For example, approximately 10¹² images (which is estimated to be approximately the number of images on the Internet as of spring 2014) can be organised automatically into a six layer hierarchy with approximately 100 clusters in each layer. A search of all of these images would then require calculation of the RDE approximately 600 times (6×100) and ranking 100 items six times, which can all easily be done in less than a second using a standard desk top PC

The execution time of the method has been tested on several randomly selected queries, such as bikes, planes, cars, and sharks. The execution time of hierarchical and non-hierarchical versions of the method when searching 65,000 images using a randomly selected query image is a few tenths of a second for non-hierarchical versions and about half of the non-hierarchical time for a hierarchical version with two levels. In the non-hierarchical version the similarity value was computed between the query image and all of the images of the lowest layer or primitive clusters. In the hierarchical version the similarity determination is made only with the top layer clusters. After determining the ‘winning’ top layer cluster, the further search at the lowest layer is performed only with the primitive clusters that correspond to the winning cluster, thereby significantly reducing the number of comparisons and hence local density calculations that are carried out. The Evolving Local Means method for forming the clusters used a cluster radius set to 150 for the lowest layer clusters and 250 for the top layer clusters. At the lowest layer all 65,000 images were grouped into 697 primitive clusters. Any primitive clusters that include a single image are discarded. At the top layer the means of the primitive clusters that were not eliminated due to the small number of images in them were further clustered using the Evolving Local Means method and a radius of 250. This resulted in 36 top layer clusters. As indicated above, the total execution time is of the order of milliseconds.

The method is scalable to greater sized data collections and is also parallelisable in nature: for example different clusters can reside on different processors. The search method can be provided entirely locally or remotely, for example as a web service

Generally, embodiments of the present invention, and in particular the processes involved in the processing of digital items, structuring digital items and searching digital items using a query digital item, employ various processes involving data stored in or transferred through one or more computer systems. Embodiments of the present invention also relate to apparatus for performing these operations. This apparatus may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method steps. A particular structure for a variety of these machines will appear from the description given below.

In addition, embodiments of the present invention relate to computer readable media or computer program products that include program instructions and/or data (including data structures) for performing various computer-implemented operations. Examples of computer-readable media include, but are not limited to, magnetic media such as hard disks, floppy disks, and magnetic tape; optical media such as CD-ROM disks; magneto-optical media; semiconductor memory devices, and hardware devices that are specially configured to store and perform program instructions, such as read-only memory devices (ROM) and random access memory (RAM). The data and program instructions of this invention may also be embodied on a carrier wave or other transport medium. Examples of program instructions include both machine code, such as produced by a compiler, and files containing higher level code that may be executed by the computer using an interpreter.

FIG. 13 illustrates a typical computer that, when appropriately configured or designed, can serve as a one of the computers used in the computer system illustrated in FIG. 1. The computer 800 includes any number of processors 802 (also referred to as central processing units, or CPUs) that are coupled to storage devices including primary storage 806 (typically a random access memory, or RAM), primary storage 804 (typically a read only memory, or ROM). CPU 802 may be of various types including microcontrollers and microprocessors such as programmable devices (e.g., CPLDs and FPGAs) and unprogrammable devices such as gate array ASICs or general purpose microprocessors. As is well known in the art, primary storage 804 acts to transfer data and instructions uni-directionally to the CPU and primary storage 806 is used typically to transfer data and instructions in a bi-directional manner. Both of these primary storage devices may include any suitable computer-readable media such as those described above. A mass storage device 808 is also coupled bi-directionally to CPU 802 and provides additional data storage capacity and may include any of the computer-readable media described above. Mass storage device 808 may be used to store programs, data and the like and is typically a secondary storage medium such as a hard disk. It will be appreciated that the information retained within the mass storage device 808, may, in appropriate cases, be incorporated in standard fashion as part of primary storage 806 as virtual memory. A specific mass storage device such as a CD-ROM 814 may also pass data uni-directionally to the CPU.

CPU 802 is also coupled to an interface 810 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 802 optionally may be coupled to an external device such as a database or a computer or telecommunications network using an external connection as shown generally at 812. With such a connection, it is contemplated that the CPU might receive information from the network, or might output information to the network in the course of performing the method steps described herein.

Although the above has generally described the present invention according to specific processes and apparatus, the present invention has a much broader range of applicability. In particular, aspects of the present invention is not limited to any particular kind of digital item and can be applied to virtually any types of digital item which can be characterized by a feature vector and where an ability to search those digital items is useful. One of ordinary skill in the art would recognize other variants, modifications and alternatives in light of the foregoing discussion.

What is claimed is:

1. A computer implemented method for searching a plurality of digital items using a query digital item, comprising:
extracting at least one feature a query digital item from a data file of the query digital item and forming a query feature vector from a plurality of numerical data items representing the at least one feature;
determining which of a plurality of first clusters is most similar to the query digital item using the query feature vector to identify a result cluster from the plurality of first clusters, wherein each of the plurality of first clusters represents a different plurality of digital items and each digital item is represented by only one of the plurality of first clusters; and
outputting a search result comprising one or more digital items from the result cluster.

2. The computer implemented method of claim 1, wherein determining further comprises calculating the aggregated similarity of all of the plurality of different digital items represented by a one of the first clusters to the query digital item for each of the plurality of first clusters using the query feature vector.

3. The computer implemented method of claim 1, wherein the plurality of first clusters are at a first level of a hierarchy of clusters, the first level is a lowest level of the hierarchy of clusters and the hierarchy of clusters further includes a plurality of second clusters at a second level of the hierarchy, the method further comprising:
determining which of the plurality of second clusters is most similar to the query digital data item to identify the plurality of first clusters by calculating the aggregated similarity of a plurality of first clusters represented by a one of the second clusters to the query digital item for each of the plurality of second clusters using the query feature vector, wherein each of the plurality of second clusters represents a different one or plurality of first clusters and each first cluster is represented by only one of the plurality of second clusters.

4. The computer implemented method of claim 1, wherein extracting at least one feature comprises extracting a plurality of features from the data file of the query digital item and forming the query feature vector from a plurality of numerical data items which respectively represent each of the plurality of features.

5. The computer implemented method of claim 1, wherein each cluster is defined by a plurality of cluster data items recursively calculated using an evolving local means method.

6. The computer implemented method of claim 1, wherein outputting a search result includes:
determining the similarity between the query digital item and each of the digital items represented by the result cluster; and
applying a threshold to select the one or more digital items to output as the search results.

7. The computer implemented method of claim 6, further comprising:
ranking the digital items represented by the result cluster based on the determined similarity, and wherein outputting the search results includes outputting the one or more digital items in rank order from more similar to less similar.

8. The computer implemented method of claim 1, wherein the digital items are images and wherein the or each feature includes one or more image features selected from the group comprising: an image feature obtained from a GIST scene description of the image; an image feature obtained from an HSV histogram of the image; an image feature corresponding to a colour moment of the image; an image feature obtained from a colour autocorreolgram of the image; an image feature obtained from a log-Gabor texture filtering of the image; and an image feature obtained from a wavelet transformation of the image.

9. The computer implemented method of claim 1, wherein the digital items are audio items and wherein the or each feature includes one or more audio features selected from the group comprising: an audio feature representing the timbral texture of the audio item; an audio feature representing the rhythmic content of the audio item; and an audio feature representing the pitch content of the audio item.

10. The computer implemented method as claimed in claim 1, and further comprising:
sending a search request over a computer network to a remote searching service; and
receiving the search result over the computer network from the remote searching service.

11. The computer implemented method as claimed in claim 10, wherein the search request includes the query feature vector.

12. The computer implemented method as claimed in claim 10, wherein the search request includes the data file of the query digital item or the location on the computer network of the data file for the query digital item.

13. A computer readable medium, or computer readable media, storing computer program code executable by a data processor, or respective data processors, to carry out the method of claim 1.

14. A data processing device, or devices, for searching a plurality of digital items using a query item, each data processing device including a data processor and the computer readable medium, or a one of the computer readable media, of claim 13.

15. A computer implemented method for processing a plurality of digital items to structure the plurality of digital items, comprising:
extracting at least one feature from a data file for each of a plurality of digital items and forming a feature vector of a plurality of numerical data items representing the at least one feature for each of the plurality of items; and
forming a plurality of first clusters by recursively calculating a plurality of first cluster data items for each of the plurality of first clusters from the feature vector using an evolving local means method, wherein each plurality of first cluster data items defines a respective one of the plurality of first clusters, and wherein each cluster of the plurality of first clusters represents a different plurality of digital items and each digital item is represented by only one of the plurality of first clusters.

16. The computer implemented method of claim 15, further comprising:
forming at least one second cluster by recursively calculating a plurality of second cluster data items for each second cluster from the first cluster data items using an evolving local means method, wherein each plurality of second cluster data items defines a respective second cluster, and wherein each second cluster represents a different one or plurality of first clusters and each first cluster is represented by only one second cluster, and wherein the plurality of first clusters are at a first level of a hierarchy of clusters, the first level is a lowest level of the hierarchy of clusters and each second cluster is at a second level of the hierarchy.

17. The computer implemented method of claim 16, further comprising:
forming a plurality of second clusters by recursively calculating a plurality of second cluster data items for each of the plurality of second clusters from the first cluster data items using an evolving local means method, wherein each plurality of second cluster data items defines a respective one of the plurality of second clusters, and wherein each cluster of the plurality of second clusters represents a different one or plurality of first clusters and each first cluster is represented by only one of the plurality of second clusters, and wherein the plurality of second clusters are at a second level of the hierarchy.

18. The computer implemented method of claim 16, wherein the plurality of second clusters are formed with a second cluster radius, the plurality of first clusters are formed with a first cluster radius and wherein the second cluster radius is greater than the first cluster radius.

19. The computer implemented method of claim 16, further comprising:
determining if the number of clusters at a lower level of the hierarchy is greater than a threshold and if so then generating at least one higher level cluster at a higher level of the hierarchy by recursively calculating a plurality of higher level cluster data items for each higher level cluster from the cluster data items for the clusters at the lower level using the evolving local means method, wherein each plurality of higher level cluster data items defines a respective higher level cluster, wherein each higher level cluster represents a different one or plurality of clusters at the lower level and each cluster at the lower level is represented by only higher level clusters.

20. The computer implemented method of claim 19, further comprising iterating the method to form a hierarchy having at least six levels.

21. The computer implemented method of claim 19, wherein the threshold is one thousand clusters.

22. The computer implemented method of claim 16, further comprising:
obtaining the data file for each of the plurality of digital items at a server by retrieving the data files over a computer network.

23. The computer implemented method of claim 19, wherein the plurality of digital items are processed to be searchable using a query digital item and further comprising:
receiving a search request including or identifying a query digital item over the computer network at the server computer from a client computer associated with a user.

24. The computer implemented method of claim 16, wherein extracting at least one feature comprises extracting a plurality of features from the data file of each digital item and forming the feature vector from a plurality of numerical data items representing each of the plurality of features for each of the plurality of digital items.

25. The computer implemented method of claim 16, wherein the digital items are images and wherein the or each feature includes one or more image features selected from the group comprising: an image feature obtained from a GIST scene description of the image; an image feature obtained from an HSV histogram of the image; an image feature corresponding to a colour moment of the image; an image feature obtained from a colour autocorreolgram of the image; an image feature obtained from a log-Gabor texture filtering of the image; and an image feature obtained from a wavelet transformation of the image.

26. The computer implemented method of claim 16, wherein the digital items are audio items and wherein the or each feature includes one or more audio features selected from the group comprising: an audio feature representing the timbral texture of the audio item; an audio feature representing the rhythmic content of the audio item; and an audio feature representing the pitch content of the audio item.

27. A computer readable medium storing computer program code executable by a data processor to carry out the method of claim 16.

28. A data processing device for processing a plurality of digital items to be structured or to be searchable using a query item, the data processing device including a data processor and a computer readable medium as claimed in claim 27.
